(19) United States
(12) Patent Application Publication
(10) Pub. No.: US 2019/0166778 A1
(43) Pub. Date: Jun. 6, 2019

(54) Hydroponic Growing System, Planting Tower and Method

(71) Applicants: Gregory Hendrick, Wenatchee, WA (US); Ivo Wieling, Rotterdam (NL)

(72) Inventors: Gregory Hendrick, Wenatchee, WA (US); Ivo Wieling, Rotterdam (NL)

(73) Assignee: Foody Vertical Gardens, LLC, Wenatchee, WA (US)

(21) Appl. No.: 15/831,304

(22) Filed: Dec. 4, 2017

(51) Int. Cl. A01G 31/06; A01G 27/02; A01G 27/00

(52) U.S. Cl. CPC A01G 31/06; A01G 27/008; A01G 27/02

(57) ABSTRACT

A hydroponic growing system is provided having a growing pot and a root distribution plate. The growing pot has a wall portion defining an elevationally-extending concavity. The root distribution plate has an outer periphery configured to be fitted in substantially level conformity within the concavity at a position elevated from a bottommost portion of the concavity and an array of raised root barriers subdividing a top surface of the root distribution plate into a plurality of distinct root beds. A method is also provided.

### CROSS REFERENCE TO RELATED APPLICATION

This application does not claim priority from any other application.

### TECHNICAL FIELD

This disclosure pertains to planting containers and techniques for growing plants. More particularly, this disclosure relates to improved systems, apparatus and methods for growing plants by watering and fertilizing the plants, and for stacking, interlocking, and supporting plating tower components.

### BACKGROUND OF THE DISCLOSURE

Techniques are known for growing plants in planting containers stacked vertically and having an irrigation system for delivering water and fertilizer to the plants. However, improvements are needed in the manner and direction in which water and fertilizer are delivered to a stack of growing pods containing plants in a planting tower and in the manner in which such towers are constructed and assembled. Further improvements are needed in the manner in which plating tower components are stacked, interlocked, and supported.

While the subject matter of this application was motivated in addressing hydroponic growing systems and methods, it is in no way so limited. The disclosure is only limited by the accompanying claims as literally worded, without interpretative or other limiting reference to the specification, and in accordance with the doctrine of equivalents.

Other aspects and implementations are contemplated.

### SUMMARY OF THE INVENTION

A plant growing system and method are provided using vertically nested growing pods that each include a pot and having stacking and interlocking structures and base supports. Such system and method further includes unique water distribution and delivery features for recirculating water and fertilizer in a closed loop system.

According to one aspect, a hydroponic growing system is provided having a growing pot and a root distribution plate. The growing pot has a wall portion defining an elevationally-extending concavity. The root distribution plate has an outer periphery configured to be fitted in substantially level conformity within the concavity at a position elevated from a bottommost portion of the concavity and an array of raised root barriers subdividing a top surface of the root distribution plate into a plurality of distinct root beds.

According to another aspect, a planting tower is provided having a growing pot, a root distribution plate, and a water distribution plate. The growing pot has a wall portion defining an elevationally-extending concavity; the root distribution plate has an outer periphery configured to be fitted in substantial horizontal conformity within the concavity at a position elevated from a bottommost portion of the concavity and an array of raised root barriers subdividing a top surface of the root distribution plate into a plurality of distinct root beds. The water distribution plate is carried beneath the root distribution plate and has a downwardly sloped radially outwardly extending water distribution surface terminating in a plurality of discharge apertures proximate a net pot containing a rooted plant.

According to yet another aspect, a method is provided for growing potted plants. The method includes: providing a planting pot with a vertical cavity, a laterally spaced apart array of adjacent growing pots elevated in the cavity each containing a plant, a root distribution plate substantially level beneath the growing pots having subdivided adjacent pocket regions each beneath one of the growing pots separated by an array of upstanding ribs, and a water distribution plate having a sloped outwardly descending surface spaced below the root distribution plate; supplying water and fertilizer to each growing pot; dropping the water and fertilizer through and down from each growing pot onto the root distribution plate; downwardly withdrawing the fertilizer and water centrally of the root distribution plate downwardly onto the water distribution plate; and accelerating the water and fertilizer outwardly from atop the water distribution plate toward an ejection aperture for delivery to a net pot provided outwardly of the aperture.

### BRIEF DESCRIPTION OF THE DRAWINGS

Exemplary embodiments of the various disclosures are described below with reference to the following accompanying drawings. The drawings may be considered to represent scale.

FIG. 1 is a perspective view from above of a hydroponic growing system in the form of a planting tower containing plants, according to one aspect.

FIG. 2 is from above of the planting tower of FIG. 1 without plants.

FIG. 3 is a front view of the planting tower of FIGS. 1-2.

FIG. 4 is a plan view from above of the planting tower of FIGS. 1-3.

FIG. 5 is a plan view from below of the planting tower of FIGS. 1-4.

FIG. 6 is a vertical centerline sectional view of the planting tower of FIGS. 1-5 taken along line 6-6 of FIG. 4.

FIG. 7 is a partial vertical sectional view taken from within the encircled region 7 of FIG. 6.

FIG. 8 is a partial vertical sectional view taken from within the encircled region 8 of FIG. 6.

FIG. 9 is a partial vertical sectional view taken from within the encircled region 9 of FIG. 6.

FIG. 10 is a partial vertical sectional view taken from within the encircled region 10 of FIG. 6.

FIG. 11 is a partial vertical sectional view taken from within encircled region 11 of FIG. 6.

FIG. 12 is a partial vertical sectional view taken from within encircled region 12 of FIG. 6.

FIG. 13 is a partial vertical sectional view taken from within encircled region 13 of FIG. 6.

FIG. 14 is a perspective view from above of a cover for a growing pod.

FIG. 15 is a perspective view from below of the cover of FIG. 14.

FIG. 16 is a perspective view from above of a cover for a reservoir tank as shown in the planting tower of FIGS. 1-3 and 6.

FIG. 17 is perspective view from below of the cover of FIG. 16.

FIG. 18 is a perspective view from above of a growing pod base as shown in the planting tower of FIGS. 1-3 and 6.

FIG. 19 is a perspective view from below of a growing pod base as shown in FIG. 18.

FIG. 20 is a perspective view from above of a root distribution plate used in the planting tower of FIGS. 1-3 and 6.

FIG. 21 is a plan view from above of the root distribution plate of FIG. 20.

FIG. 22 is an exploded perspective view from above of reservoir tank and growing pod components for the planting tower of FIGS. 1-3 and 6.

FIG. 23 is a vertical centerline sectional view taken along the same cutting line as FIG. 6.

FIG. 24 is a perspective view from above of a hydroponic growing system in the form of a pair, or row of planting towers containing plants, according to another aspect.

FIG. 25 is a vertical centerline sectional view taken of the planting tower of FIG. 24 along line 25-25 of FIG. 24.

### DETAILED DESCRIPTION OF THE EMBODIMENTS

This disclosure is submitted in furtherance of the constitutional purposes of the U.S. Patent Laws “to promote the progress of science and useful arts” (Article 1, Section 8).

The terms “a”, “an”, and “the” as used in the claims herein are used in conformance with long-standing claim drafting practice and not in a limiting way. Unless specifically set forth herein, the terms “a”, “an”, and “the” are not limited to one of such elements, but instead mean “at least one”.

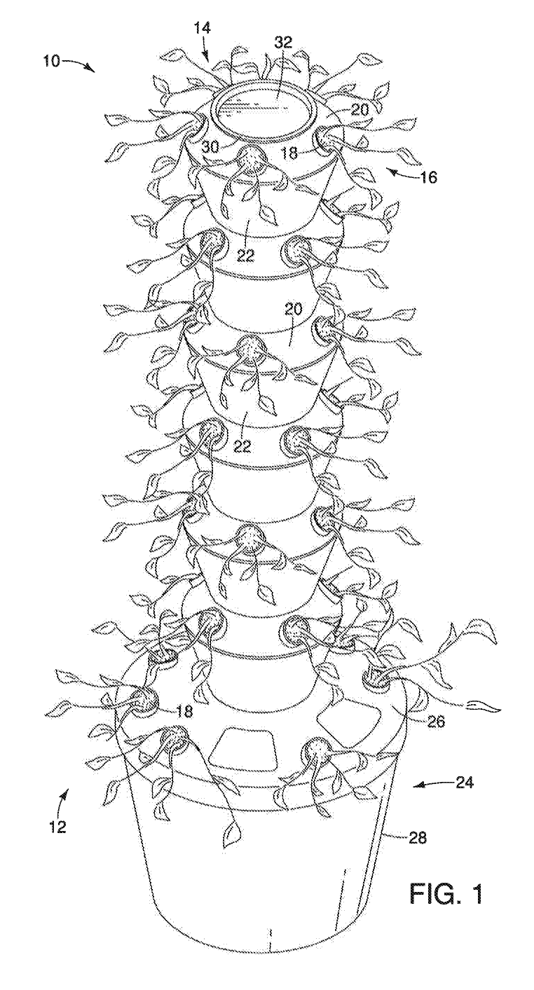

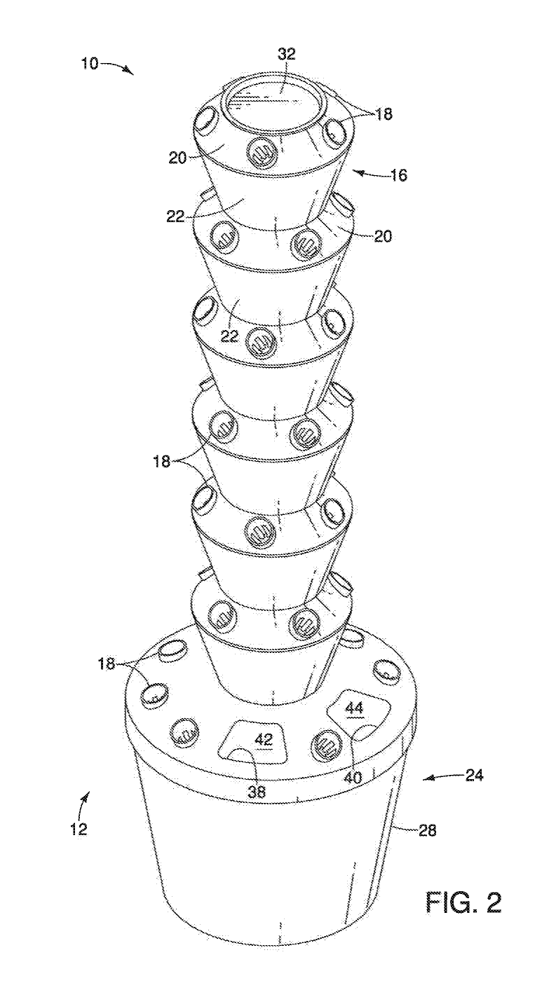

FIG. 1 illustrates one construction for a hydroponic growing system 10 in the form of a planting tower 12 having a vertical stack of interlocking growing pods, or growing containers 16 affixed atop a reservoir tank 24 holding a closed-loop supply of water and nutrients for irrigating plants 14. A circumferential array of spaced apart net pots 18 are affixed atop cover 26 and covers 20 for reservoir tank 24 and growing pods 16, respectively, as shown in FIGS. 1-4. A plug of bituminous material and a seed are loaded into each net pot 18, as shown in FIG. 1. Base 28 of reservoir tank 24 contains water and fertilizer which is pumped from tank 24 up through the center of the stack of growing pods 16 to the topmost growing pod 16, where such water and fertilizer takes a circuitous path via gravity feed downwardly through a base 22 of each growing pod 16. A cover 32 is received over top opening 30 in the top-most growing pod 16, as shown in FIGS. 1 and 2.

As shown in FIG. 2, a pair of trapezoidal-shaped access ports 38 and 40 are provided through cover 26 of reservoir tank 24 on planting tower 12 of system 10 to provide access for replenishing water and fertilizer, or doing internal maintenance and cleaning. A pair of complementary snap-fit covers 42 and 44 close off ports 38 and 40 when not in use. Likewise, top cover 32 cooperates with covers 42 and 44 to minimize evaporative loses from inside tower 12 and to prevent intrusion of foreign matter.

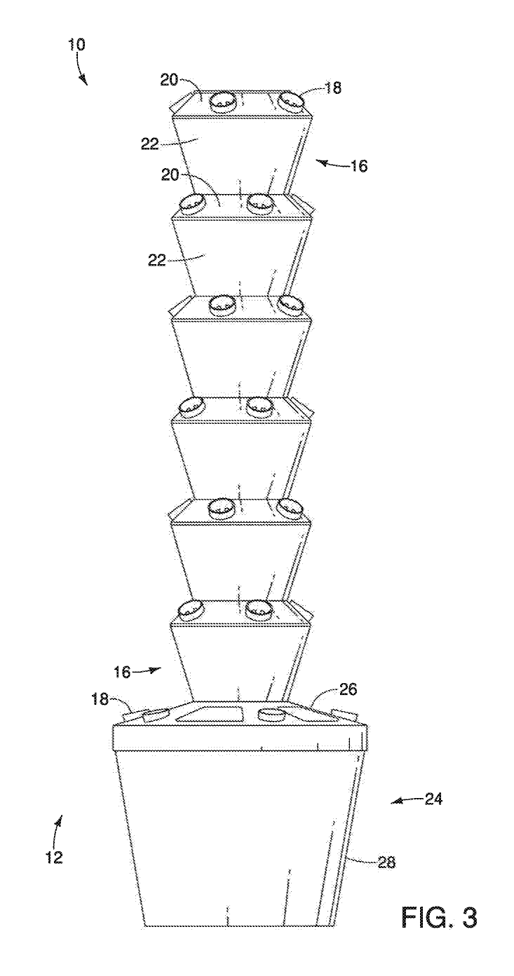

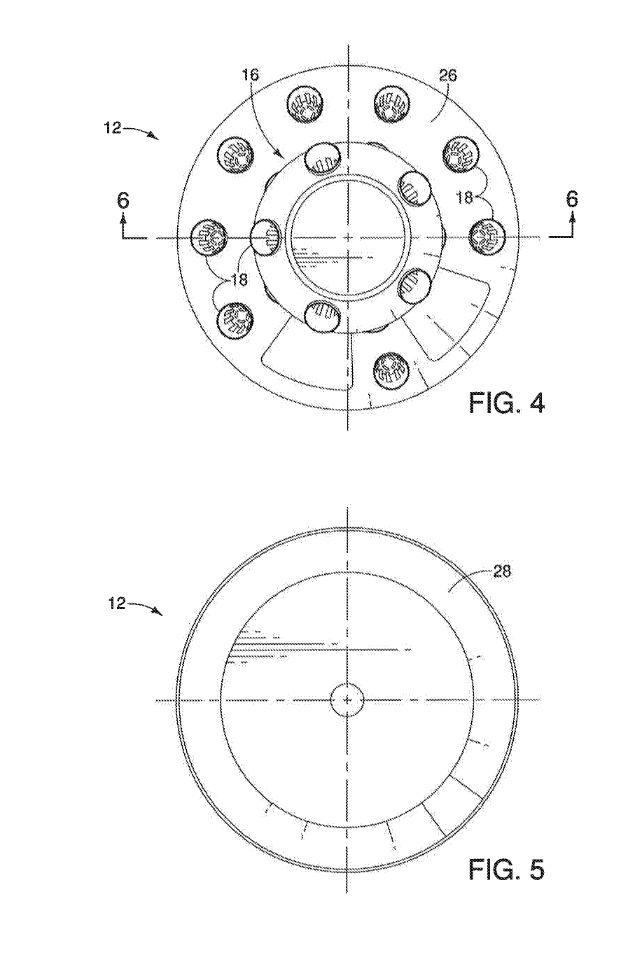

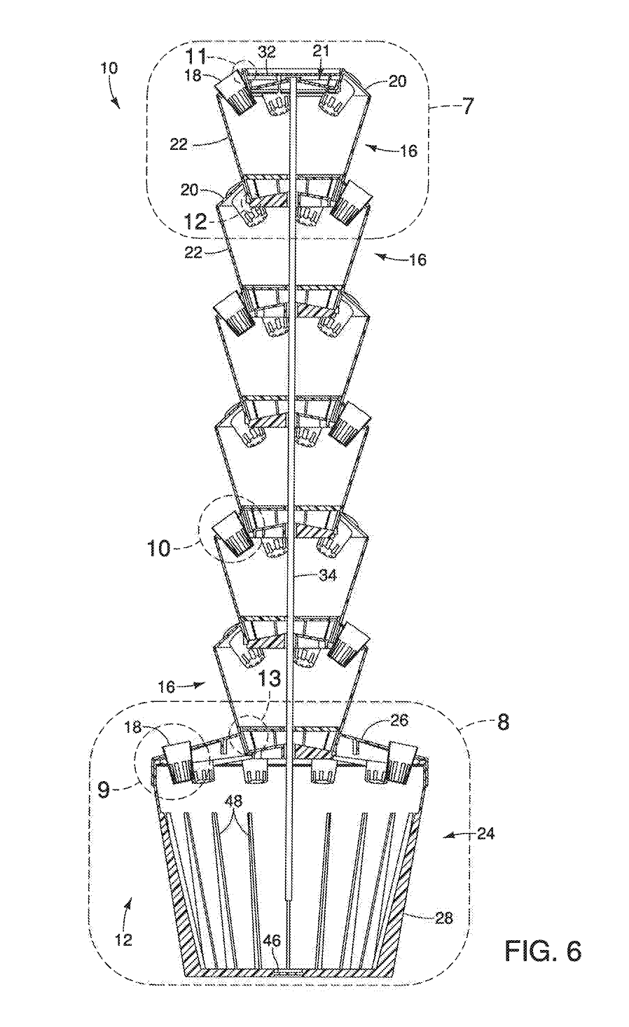

Planting bases 22 of planting pods 16 for system 10 are locked together in assembly atop cover 26 of reservoir tank 24, while cover 26 is affixed atop base 28, as shown in FIG. 3. Further details are provided below with reference to FIGS. 6, 8 and 9. A resulting circumferential array of net pots 18 are distributed about growing pod 16 along cover 26, as shown in FIG. 4. Base 28 supports the tower along a bottom portion, as shown in FIG. 5.

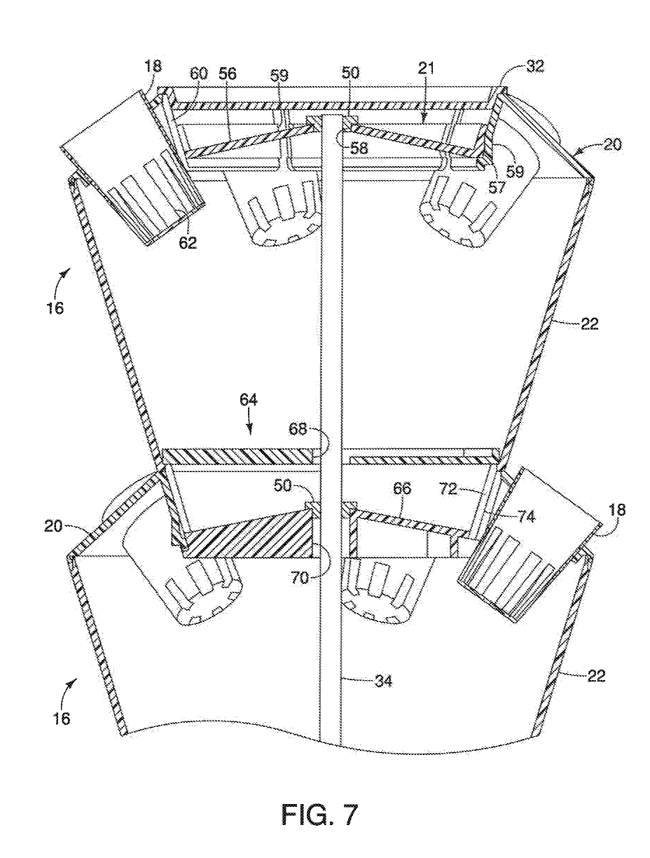

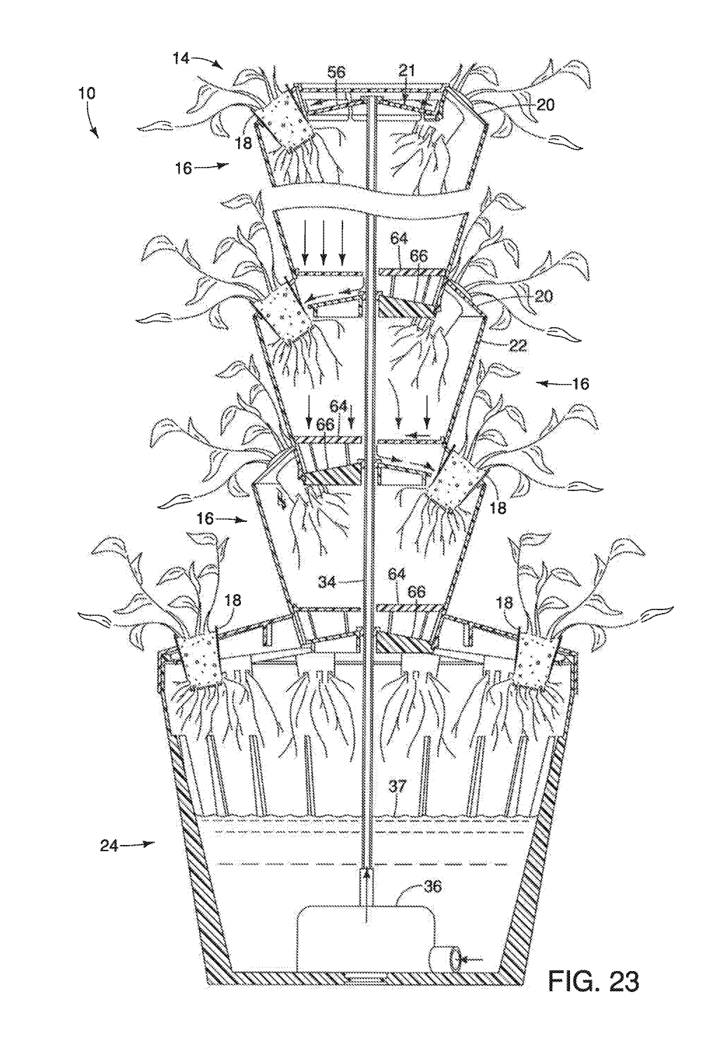

FIG. 6, along with portions depicted in FIGS. 7-13, show in cross section the construction details of planting tower 12 for system 10. A vertical stack of six growing pods 16 are affixed together in interlocking relation atop reservoir tank 24. Water and fertilizer (not shown) are delivered in a solution from within reservoir tank 24 via a water pump 36 (see FIG. 23) upwardly via a plastic supply tube 34 where it is released beneath a cap, or cover 32 of the topmost growing pod 16. Pump 36 is omitted to show a cylindrical flat dimple 46 provided in a bottom surface of tank 24. A complementary male dimple (not shown) is provided on a bottom surface of pump 36 centered within an array of inner surface reinforcing ribs 48 integrally molded in tank 24 to provide lateral stability to the pump and the supply tube. Water and fertilizer moves downwardly through the hydroponic planting tower 12 via gravity to feed each net pot 18 in a very specific cascading pattern, shown below in greater detail with reference to FIG. 23. In operation, a timer is placed on the water pump to run the pump for selected, timed periods, after which the root systems of each plant are gravity drained and left free of water and fertilizer so as to mitigate risk of root rot.

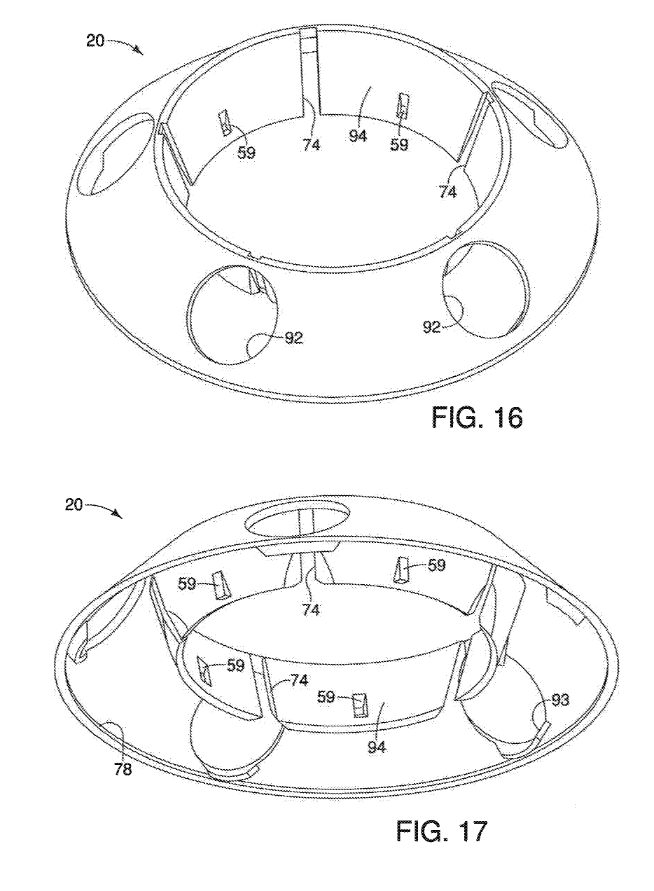

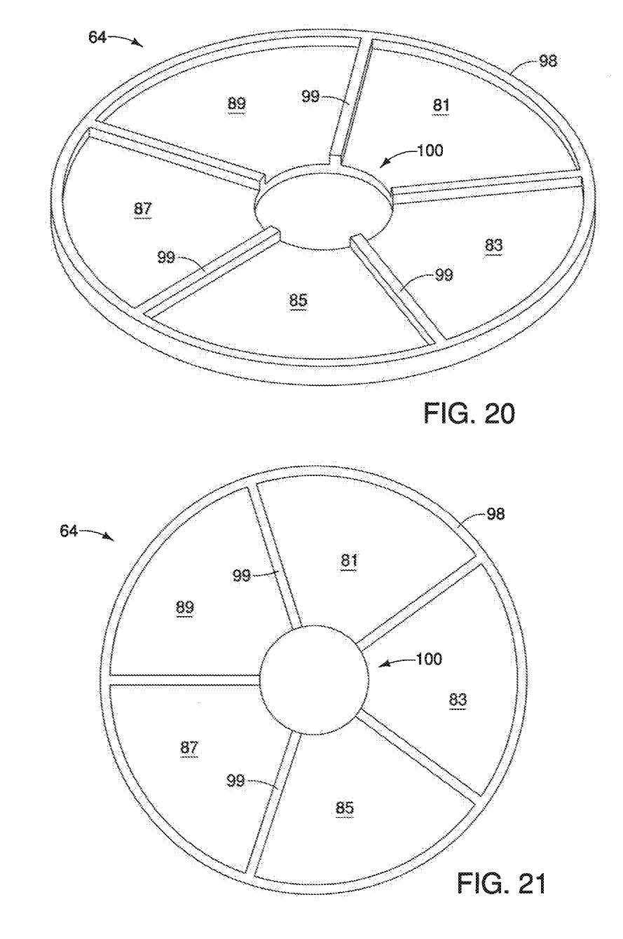

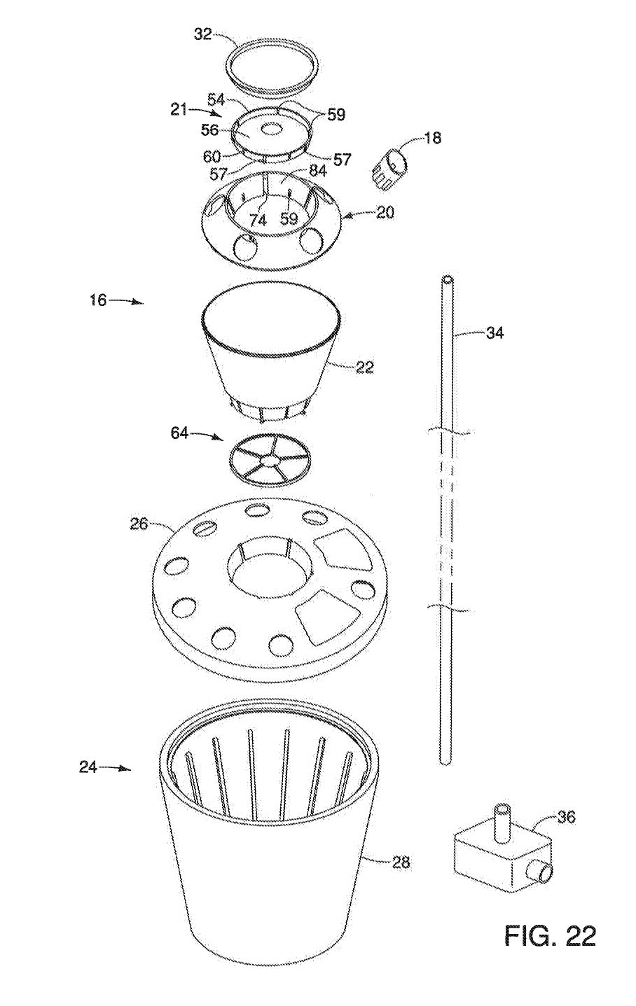

As shown in FIG. 7, supply tube 34 ejects a solution of pumped water and fertilizer beneath cap 32 of topmost growing pod 16. A water distribution tray 21 is affixed to cover 20 with fingers 57 (see FIGS. 7 and 22) interlocking in assembly with pockets 59 in cover 20 (see FIGS. 16 and 17). Tray 21 provides a recess having a frustoconical, outwardly and downwardly sloped water distribution plate 56 providing a bottom surface encircled by a circumferential sidewall 54 in which fingers 57 are integrally molded. Such construction of snap-fit tray 21 enables use of a single cover 20 throughout planting tower 12. Tube 34 extends upwardly through a cylindrical aperture 58 and a washer 50 which impedes water transmission between tube 34 and an inner diameter of washer 50 via aperture 58. A circumferential array of vertical slots, or passages 60 are positioned to deliver water and fertilizer in a radially outwardly extending direction down along a flat and horizontal water distribution plate 56 where the water and fertilizer passes through a circumferential array of slits, or passages 62 in each net pot 18. Water drips through a bituminous plug containing a plant in net pot 18 and drops vertically onto a root distribution plate 64. A solution of water and fertilizer is collected atop plate 64 in a subdivided grid pattern of arctuate segments, or sectors 81, 83, 85, 87 and 89 (see FIGS. 20 and 21) and flows radially inwardly through an arcuate drainage slot 100 where it is withdrawn downwardly through a cylindrical aperture 68 (see FIG. 7), as shown below in greater detail with reference to FIGS. 20 and 21. Individual sectors 81, 83, 85, 87 and 89 (see FIGS. 20 and 21) on the root plate 64 are defined by upstanding ribs 99 and cylindrical outer rib 98 and include the topmost horizontal surface of the root plate 64 between the upstanding ribs 98 and 99. Each sector 81, 83, 85, 87 and 89 is positioned directly beneath a respective net pot 18 to define a respective root bed and encourages formation of a segregated root ball between ribs 99 (see FIGS. 20 and 21) on the boundary of each sector 81, 83, 85, 87 and 89, which facilitates easier removal of an individual plant and net pot 18 when transferring, removing, or rotating plants.

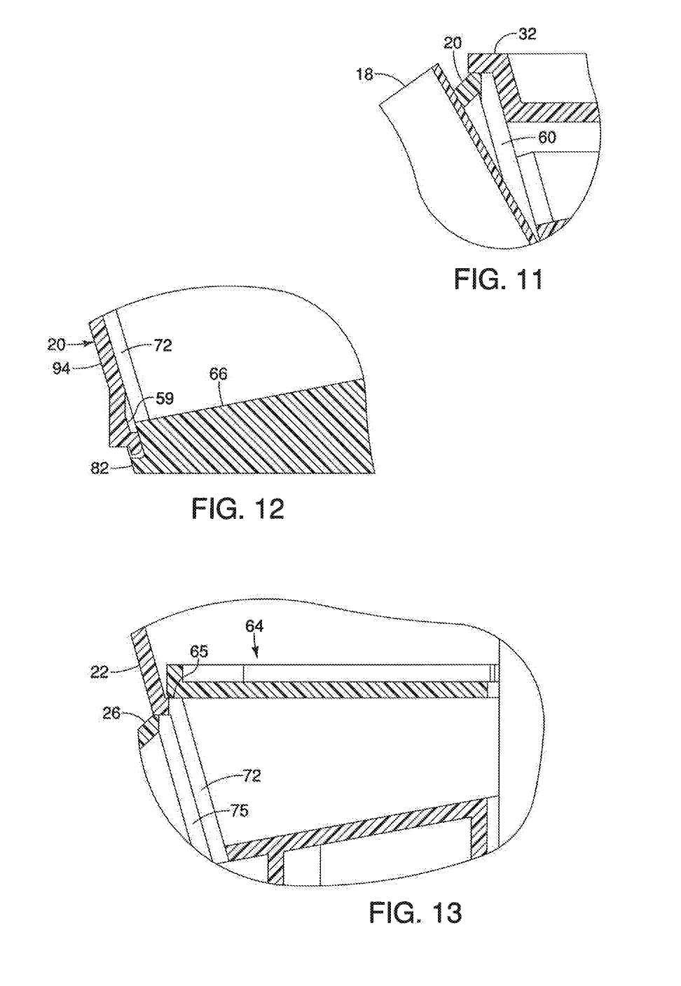

A water distribution plate 66 is provided within pot 22 spaced vertically below horizontal root distribution plate 64. Plate 66 has a topmost conical surface for distributing water and fertilizer in a radially outward direction for delivery through vertical slots, or passages 72 and 74 in base 22 and cover 20, respectively. Plate 66 has an outwardly downwardly extending slope of from about 10 to about 30 degrees from horizontal. More preferably, plate 66 has an outwardly downwardly extending slope from 14 to about 20 degrees in order to generate sufficient riparian flow energy and speed that ejects water and fertilizer onto and into a respective net pot 18 via aligned slots 72 and 74 (see FIG. 7). Plate 21 (see FIG. 7) is constructed with similar top surface angles as plate 66 detailed above for a similar purpose of generating flow energy for delivery to plants. Tube 34 passes through plate 66 via cylindrical aperture 70. A plastic washer 50 closes off the top of plate 66 around aperture 70, restricting flow of water and fertilizer back down aperture 70. Washer can be a flat washer, or a washer with an integral reduced-diameter plug base portion received in aperture 70. Plate 66 forms a bottom of base 22. In assembly, plate 66 locks in rotation within adjacent cover 20, as described below in greater detail with reference to FIG. 12. In such locked configuration, slots 72 and 74 are aligned adjacent to each net pot 18 for delivering water and fertilizer into/onto a root system for a plant within each net pot 18.

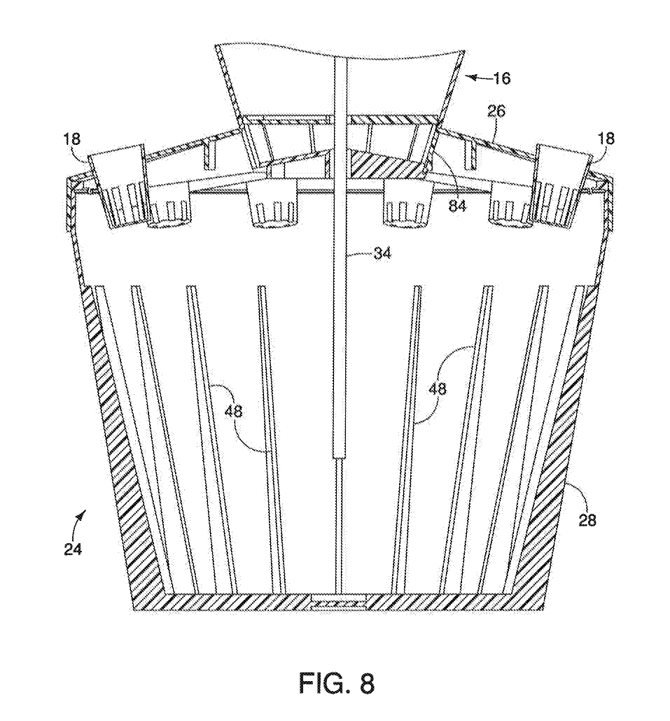

FIG. 8 illustrates a circumferential array of integrally formed inner surface reinforcing ribs 48 provided on an inner surface of base 28 of reservoir tank 24. Ribs 48 are formed within base 28 as a single injection molded plastic piece. A narrowed bottom portion of the base pot 22 (see FIG. 7) of growing pod 16 is fitted coaxially within a cylindrical inner wall 84 of cover 26 with pot 22 being rotated, either clockwise or counterclockwise, to lock pod 16 onto tank 24. Water and fertilizer drop from each net pot 18 for collection and redelivery from base 28 via a fluid, or water pump (not shown) for delivery to the top of the tree via supply tube 34.

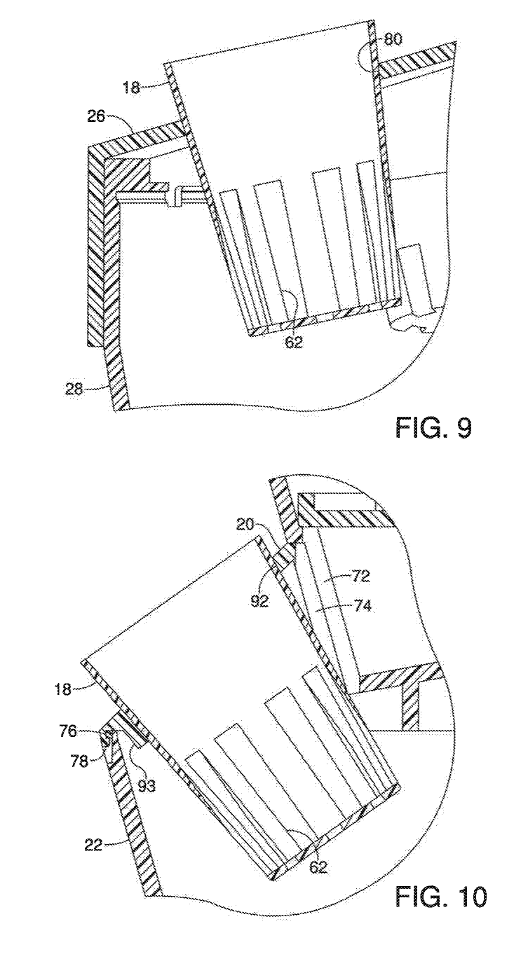

As shown in FIG. 9, each net pot 18 has a tapered outer wall that is received in a cylindrical aperture 80 in top 26. Cover 26 is received over base 28 in snug relationship therebetween. A circumferential array of vertical slots or apertures 62 in the wall of net pot 18 provides for root growth out of pot 18 and for water and fertilizer to drop through into base 28 for recollection and redelivery to the top of the plating tower via the pump.

FIG. 10 illustrates the mounting of net pots 18 into cover 20 in a manner similar to that shown in FIG. 9. More particularly, a cylindrical aperture 92 in cover 20 includes an arcuate lip, or flange 93 that helps support net pot 18 when received in aperture 20. Alignment of slots 72 and 74 by rotating relative positions of an interlocking pot 18 and cover 20 enables water and fertilizer to drop onto roots that extend from net pot 18 via slots 62, as well as to enter net pot 18 via slots 62. Additionally, a snap-fit attachment for affixing cover 20 atop base 22 is detailed as a radially-inwardly extending bead 78 on cover 20 that snaps in interference fit over a radially-outwardly extending bead 76 on base 22. Cover 20 and base 22 are each made from injection molded plastic, and elastic yielding of cover 20 enables override of bead 78 about bead 76 during assembly and disassembly.

FIG. 11 shows orientation of cover 32 atop cover 20 adjacent to a net pot 18. Slot 60 is configured adjacent to net pot 18 to provide water and fertilizer to a plant within net pot 18.

As shown in FIG. 12, base 66 has a circumferential array of equidistant spaced-apart and radially outwardly extending locking fingers 82 that are locked in rotated relation beneath a bottom edge of flange, or inner wall 94 of cover 20 (see FIGS. 16 and 17). Such fingers are received downwardly in slots 74 and the associated pot is then rotated so that fingers 82 engage under flange 94 (see FIGS. 16 and 17) to lock the pot to the cover of an adjacent pot there below.

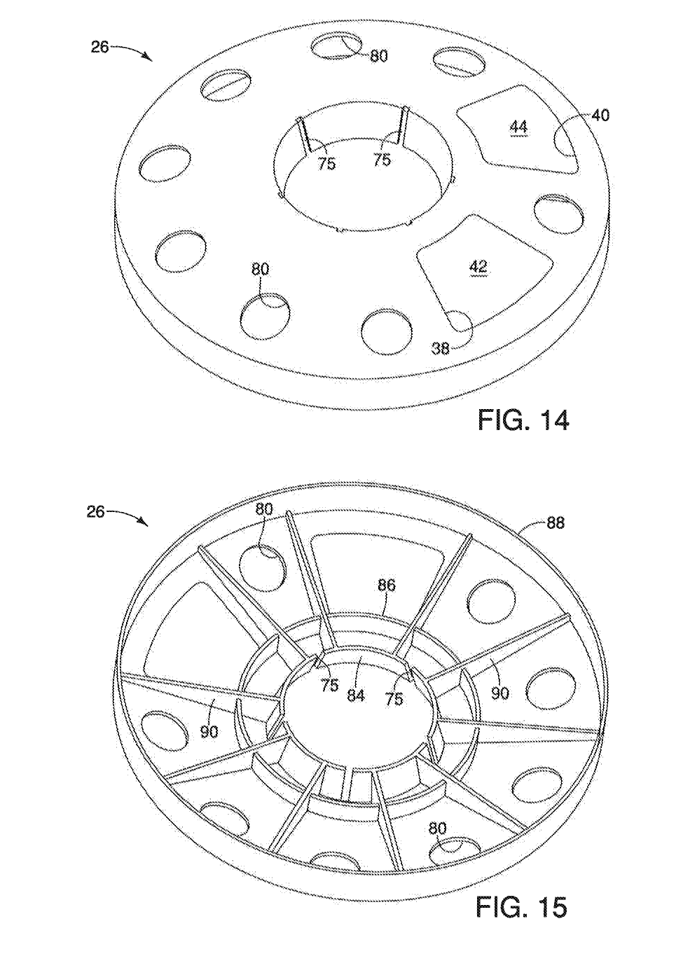

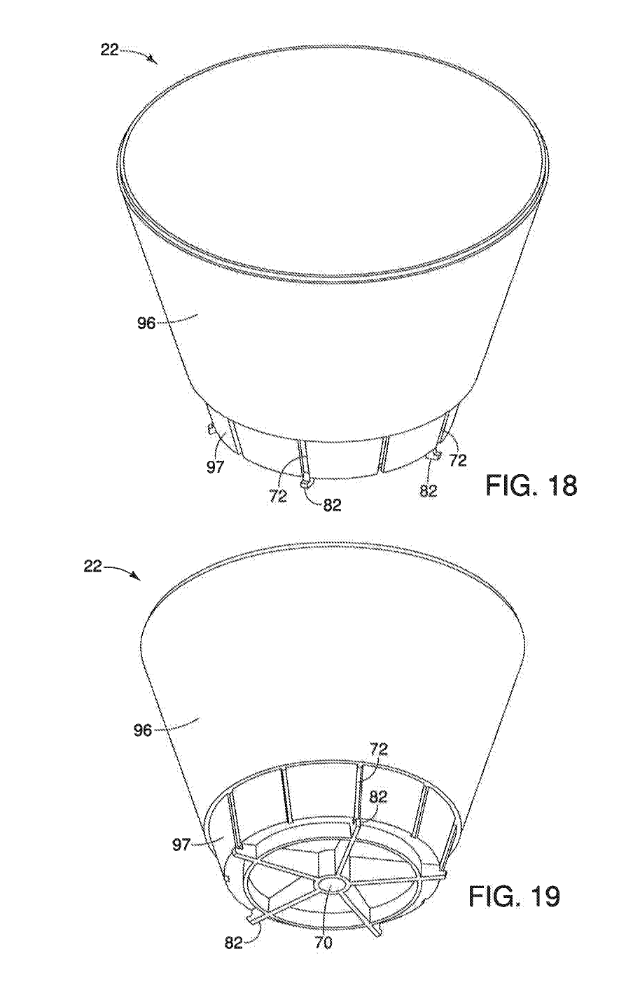

FIG. 13 illustrates the manner in which root distribution plate 64 is seated on a circumferential shelf provided by base 22 along the top end of slot 75 where base 22 transitions to a smaller dimension, forming a circumferential support shelf 65, as shown in FIGS. 18 and 19 by way of surfaces 96 and 97. Base 22 is affixed atop cover 26 in a locking relationship similar to that used to lock base 22 onto adjacent cover 20 as shown previously with reference to FIG. 12 using slots 75 and surface 84, as shown with reference to FIGS. 14 and 15. Shelf 65, along with interlocking features between adjacent parts, such as base 22 and cover 20, facilitate quick and easy assembly and disassembly when installing, repairing, and/or cleaning large arrays of such systems in a commercial or industrial setting.

FIGS. 14 and 15 show construction details of cover 20. More particularly, slots 75 are provided in an equidistant spaced-apart circumferential array extending through a circumferential inner reinforcing wall 84 (see FIG. 15). In a similar manner, an equidistant spaced-apart circumferential array of apertures, or cylindrical through-holes 80 are provided in cover 20 each for receiving a net pot (not shown). However, at two locations, access ports 38 and 40 are provided in place of a hole 80 to enable internal access and maintenance within the reservoir tank. Snap fit covers 42 and 44 affixed atop each port 38 and 40 to close out the port using small peripheral finger tabs (not shown). A circumferential array of equally spaced-apart and radially extending reinforcing ribs 90 are integrally molded into cover 20, along with a tapering cylindrical inner wall 84, circumferential middle wall 86, and circumferential outer wall 88.

FIGS. 16 and 17 show construction details for cover 20. More particularly, an equidistant spaced-apart circumferential array of through-slots 74 are provided in a tapering cylindrical wall portion, or inner wall 94. An equidistant spaced-apart circumferential array of apertures, or cylindrical through-holes 92 are provided outwardly of each slot 74 for supporting a respective net pot (not shown). As shown in FIG. 17, each slot 74 has a tapering and chamfered outer bottom edge to facilitate alignment of locking fingers 82 (see FIGS. 18 and 19) when loading and unloading such fingers from slots 74. Additionally, an arcuate support wall 93 is provided along a bottom of each aperture 92 (see FIG. 16). Furthermore, radially inwardly extending and integrally molded circumferential bead 78 is shown.

Construction details of base 22 are shown in FIGS. 18 and 19. More particularly, base 22 is constructed as a single plastic injection molded part. As shown in FIGS. 18 and 19, base 22 includes an enlarged tapered cylindrical surface, or frustoconical surface 96 and a reduced diameter tapered cylindrical surface, or frustoconical surface 97. Cylindrical shelf 65 (see FIG. 13) is formed where surfaces 96 and 97 transition. Alternating through-slots, or vertical apertures 72 terminate at a bottom end proximate a locking finger 82 along surface 97. As shown in FIG. 19, locking fingers 82 are integrally formed in the bottom of base 22 extending from a radial array of enforcing ribs joined by a circumferential rib with aperture 70 extending through the bottom of base 22.

FIGS. 20 and 22 illustrate construction details of root distribution plate 64 which is injection molded from a single piece of plastic material. A cylindrical outmost rib, or wall portion 98 extends upwardly about an outer periphery of plate 64. An equidistant spaced-apart circumferential array of radially extending ribs 99 also extend upwardly along plate 64. Along a radial innermost cylindrical periphery of aperture 68, a radial innermost gap 100 is provided between each adjacent pair of radial ribs 99 to enable water and fertilizer to flow in a radial inward direction for passage through aperture 68 in a downward direction onto a slope water distribution plate 66 (see FIG. 6).

Component details showing in exploded view the assembly of a selected topmost growing pod 16 and bottommost reservoir tank 24 are depicted in FIG. 22. It is understood that additional growing pods 16 may be stacked between uppermost pod 16 and lowermost reservoir tank 24. Topmost growing pod 16 receives water distribution plate, or tray 21 in snap-fit relation within an inner surface of cover 20 and cap 32 is affixed atop cover 20. Individual net pots 18 are then carried by cover 20, as well as by cover 26. Base 22 then locks via rotation onto an adjacent cover 26 (or 20) in assembly. Cover 26 nests atop a topmost edge of base 28, while supply tube 34 and pump assembly 36 are supported in the bottom of base 28.

FIG. 23 is a vertical centerline sectional view with portions removed corresponding with the view shown in FIG. 7, but further showing potted plants (bituminous plug and plant) in each net pot 18 and illustrating the delivery path for water and fertilizer in a closed loop supply system through hydroponic growing system 10. Pump 36, such as an aquarium pump, withdraws water and fertilizer 37 from within reservoir tank 24 and delivers it vertically upwardly via supply tube 34 where it is ejected onto plate 56 and dispersed radially outwardly and downwardly with downslope flow velocity to supply net pots 18 along cover 20. Water and fertilizer then drops from net pots 18 onto root plate 64 where it moves radially inwardly for passage down onto water distribution plate 66. This process is repeated through each growing pod 16 until finally reaching reservoir tank 24 where the remaining water and fertilizer returns into tank 24. In this way, plants 14 are irrigated according to a delivery schedule that is coordinated with a timer suppling power to pump 36 for selected durations and at specific intervals to initial watering within system 10. In addition, the self-contained system significantly reduces evaporative losses, reducing water supply needs.

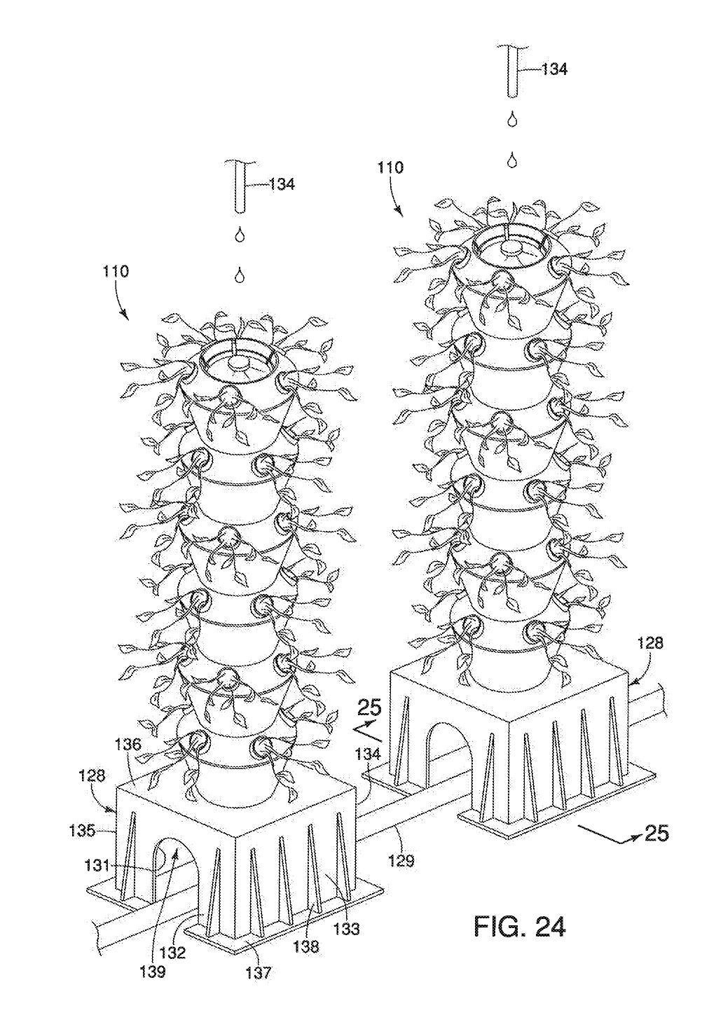

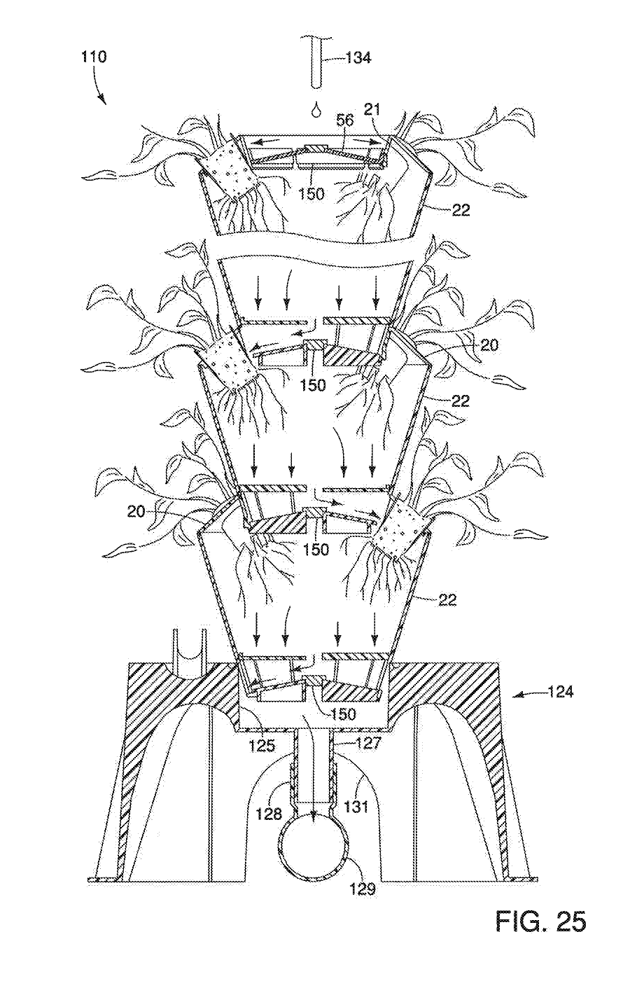

FIGS. 24 and 25 illustrate an alternative construction hydroponic growing system 110 configured for use with an overhead drip irrigation arrangement using drip lines 134 for feeding water and fertilizer into the top of each system 110. Systems 110 each include a saddle support base 128 in substitution for the reservoir tank 24 used in the prior construction of FIGS. 1-13. More particularly, base 128 includes a pair of clearance apertures 131 configured to overlie a water/fertilizer collection line 129 that returns water and fertilizer back to a main pumping tank (not shown) that feeds drip lines 134.

FIG. 25 shows in vertical centerline sectional view system 110. More particularly, water and fertilizer is fed from drip source 134 onto water distribution plate 56 of tray 21. A central plug 150 is placed within a bore in plate 56, as well as in center apertures found in additional water distribution plates in system 110. Water and fertilizer flows through system 110 in a manner similar to system 10 (of FIGS. 1-23). Water and fertilizer exits centrally from the bottom of the bottommost base 22 into saddle, or support base 124 within a central cavity 125 of base 124. Cavity 125 terminates in a central down pipe 127 into a transition fitting 128 affixed to a longitudinal collection pipe 129.

As shown above with reference to two versions, structural components are made from plastic or injection molded plastic. However, it is understood that any suitable structural material can be used to make components parts including metal, clay, ceramic, composite, or any other suitable material.

In compliance with the statute, the various embodiments have been described in language more or less specific as to structural and methodical features. It is to be understood, however, that the various embodiments are not limited to the specific features shown and described, since the means herein disclosed comprise disclosures of putting the various embodiments into effect. The various embodiments are, therefore, claimed in any of its forms or modifications within the proper scope of the appended claims appropriately interpreted in accordance with the doctrine of equivalents.

What is claimed is:

1. A hydroponic growing system, comprising:
a growing pot having a wall portion defining an elevationally-extending concavity; and
a root distribution plate having an outer periphery configured to be fitted in substantially level conformity within the concavity at a position elevated from a bottommost portion of the concavity and an array of raised root barriers subdividing a top surface of the root distribution plate into a plurality of distinct root beds.

2. The growing system of claim 1, wherein the pot comprises a side wall and a bottom wall configured as a surface of revolution about a central axis.

3. The growing system of claim 2, wherein the bottom wall is cylindrical and the root distribution plate is cylindrical with a central cylindrical aperture.

4. The growing system of claim 3, wherein the root distribution plate includes a circumferential array of equidistant spaced apart and radially extending raised ribs projecting upwardly from a top surface of the cylindrical root distribution plate communicating along an outer periphery with an outermost cylindrical raised rib and along an inner periphery with an innermost cylindrical raised rib about the cylindrical aperture.

5. The growing system of claim 4, further comprising a plurality of drainage channels provided in one of the outermost cylindrical raised rib and the innermost cylindrical raised rib.

6. The growing system of claim 1, wherein each raised root barrier comprises a radial sector atop the root distribution plate.

7. The growing system of claim 6, wherein the radial sector includes an outlet in the raised root barrier provided in one of a radial outer portion and a radial inner portion.

8. The growing system of claim 1, further comprising a water distribution plate carried beneath the root distribution plate having a sloped radially outwardly distributing water distribution surface terminating in a plurality of discharge apertures proximate a pot with a rooted plant.

9. The growing system of claim 8, wherein each discharge aperture comprises a vertical slot extending through a bottom outer periphery of the growing pot.

10. A planting tower, comprising:
a growing pot having a wall portion defining an elevationally-extending concavity;
a root distribution plate having an outer periphery configured to be fitted in substantial horizontal conformity within the concavity at a position elevated from a bottommost portion of the concavity and an array of raised root barriers subdividing a top surface of the root distribution plate into a plurality of distinct root beds; and
a water distribution plate carried beneath the root distribution plate having a downwardly sloped radially outwardly extending water distribution surface terminating in a plurality of discharge apertures proximate a net pot containing a rooted plant.

11. The planting tower of claim 10, further comprising a cover affixed atop the growing pot having a cavity.

12. The planting tower of claim 10, wherein each root barrier comprises a contiguous upstanding outer peripheral wall portion extending upwardly from a top surface of the root plate.

13. The planting tower of claim 12, wherein each root plate further comprises a central through-hole and a radially inwardly extending opening provided in the upstanding peripheral wall portion configured to provide water withdrawal from atop the top surface.

14. The planting tower of claim 10, wherein the root barrier further comprises a pair of upstanding ribs extending radially outwardly from the central through-hole and an arcuate rib extending between the pair or upstanding ribs at a radial outermost end.

15. A method for growing potted plants, comprising:
providing a planting pot with a vertical cavity, a laterally spaced apart array of adjacent growing pots elevated in the cavity each containing a plant, a root distribution plate substantially level beneath the growing pots having subdivided adjacent pocket regions each beneath one of the growing pots separated by an array of upstanding ribs, and a water distribution plate having a sloped outwardly descending surface spaced below the root distribution plate;
supplying water and fertilizer to each growing pot;
dropping the water and fertilizer through and down from each growing pot onto the root distribution plate;
downwardly withdrawing the fertilizer and water centrally of the root distribution plate downwardly onto the water distribution plate; and
accelerating the water and fertilizer outwardly from atop the water distribution plate toward an ejection aperture for delivery to a net pot provided outwardly of the aperture.

16. The method of claim 16, wherein each net pot includes a plurality of apertures, and further comprising delivering water and fertilizer from the ejection aperture with momentum through the apertures in the net pot.

17. The method of claim 16, wherein the water distribution plate has a sloped outwardly descending surface of between 14 and 20 degrees from horizontal.

18. The method of claim 16, wherein the water distribution plate has a sloped outwardly descending surface of between 10 and 30 degrees from horizontal.

19. The method of claim 16, wherein the adjacent pocket regions each comprise a horizontal top surface and an upstanding rib atop the top surface having an outlet portion along a radial innermost portion, and further comprising directing water and fertilizer contained above the top surface by the upstanding rib to flow radially inwardly through the outlet portion.
